(19) United States
(12) Patent Application Publication
(10) Pub. No.: US 2004/0240346 A1
(43) Pub. Date: Dec. 2, 2004

(54) Optical disk apparatus and optical disk processing method

(75) Inventor: You Yoshioka, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/819,330

(22) Filed: Apr. 7, 2004

(30) Foreign Application Priority Data
May 30, 2003 (JP) 2003-154252

(51) Int. Cl. G11B 7/00; G11B 5/09

(52) U.S. Cl. 369/47.27; 369/124.05; 369/59.15; 369/59.27

(57) ABSTRACT

An optical disk apparatus includes a generating unit which generates a wobble signal on the basis of a reflected light beam of an optical disk, a multiplying unit which multiplies the wobble signal and an oscillation wave, an integral processing unit which receives a multiplication result of the multiplying unit to integrate the multiplication result, an oscillating unit which generates the oscillation wave whose oscillation frequency is controlled on the basis of integral result of the integral processing unit, and a processing unit which processes information on the optical disk on the basis of the oscillation wave which is of a wobble PLL signal. In the optical disk apparatus of the invention, binarization is not performed unlike the conventional apparatus, and the wobble signal is compared to the oscillation wave in a signal area, so that the wobble PLL signal which is highly resistant to noise following the wobble is obtained.

### CROSS-REFERENCE TO RELATED APPLICATIONS

This application is based upon and claims the benefit of priority from prior Japanese Patent Application No. 2003-154252, filed May 30, 2003, the entire contents of which are incorporated herein by reference.

### BACKGROUND OF THE INVENTION

1. Field of the Invention

The present invention relates to an optical disk apparatus, particularly to the optical disk apparatus and an optical disk processing method for treating a wobble signal.

2. Description of the Related Art

In recent years, the optical disk apparatus is improved and the optical disk apparatus becomes widespread. Even in technologies of this field, higher-level technology is demanded. One of the technologies of the filed is to detect a wobbled pre-groove provided on an optical disk and to use a wobble clock generated according to the wobbled pre-groove. However, the optical disk becomes faster and denser year by year. As a result, the wobble clock signal tends to become unstable.

In the prior art (Jpn. Pat. Appln. KOKAI Publication No. 2000-207745) concerned with the wobble clock signal, there is an example disclosing a wobble clock generating circuit which performs high-speed access. In Jpn. Pat. Appln. KOKAI Publication No. 2000-207745, a plurality of band pass filter (BPF) circuits are provided, and the optimum BPF circuit is selected from the plurality of BPF circuits even in the case where the number of revolutions of the optical disk is different. Accordingly, noise is removed and the stable wobble clock signal is supplied.

However, in the prior art described above, since it is necessary to prepare the plurality of BPF circuits, the circuit becomes a larger scale. Further, as the number of revolutions of the optical disk is changed, the BPF circuit which correctly corresponds to the change in the number of revolutions can not be prepared and the noise can not be completely removed, so that the perfect wobble clock signal can not be obtained.

That is, in the prior art described above, in a PLL circuit for the wobble clock, generally, after a reproduction signal from an optical pickup is converted into a push-pull signal by an RF amplifier, the push-pull signal is amplified to a certain level, and large or small input signal is determined with a predetermined threshold to slice the input signal into a binarized signal of “1” and “0” in a binary slicing circuit. Phase difference comparison of the binarized signal and oscillator output is performed, smoothing interpolation of the binarized signal is performed in the PLL circuit which performs feedback of phase error to an oscillator, and the binarized signal is used as a wobble reproduction clock.

However, as described later, since the binarized signal becomes one which easily shows different timing by influence of the noise, the phase difference comparison between the binarized signal and the oscillator output can not be correctly performed. Therefore, there is a problem that, by the influence of the noise, a capture range of a wobble PLL signal becomes narrower or a trouble in which the phase lock is unlocked is generated.

### BRIEF SUMMARY OF THE INVENTION

An optical disk apparatus according to an aspect of the invention comprises a generating unit which generates a wobble signal in response to a wobbled groove on an optical disk on the basis of a reflected light beam detected from the optical disk, a multiplying unit which receives the wobble signal from the generating unit and a given oscillation wave and multiplies the wobble signal and the oscillation wave, an integral processing unit which receives a multiplication result of the multiplying unit and integrates the multiplication result, an oscillating unit which generates the oscillation wave and supplies the oscillation wave to the multiplying unit, an oscillation frequency of the oscillation wave being controlled on the basis of integral result of the integral processing unit, and a processing unit which processes information on the optical disk on the basis of the oscillation wave from the oscillating unit.

### BRIEF DESCRIPTION OF THE SEVERAL VIEWS OF THE DRAWING

FIG. 1 is a block diagram showing an optical disk apparatus according to one embodiment of the invention;

FIG. 2 is a block diagram showing the optical disk apparatus according to another embodiment of the invention;

FIG. 3 is a timing chart showing a process of generating a wobble PLL signal in the optical disk apparatus according to one embodiment of the invention; and

FIG. 4 is a block diagram showing another configuration of a wobble PLL circuit in the optical disk apparatus according to one embodiment of the invention.

### DETAILED DESCRIPTION OF THE INVENTION

Referring to the accompanying drawings, the optical disk apparatus according to one embodiment of the invention will be described in detail below.

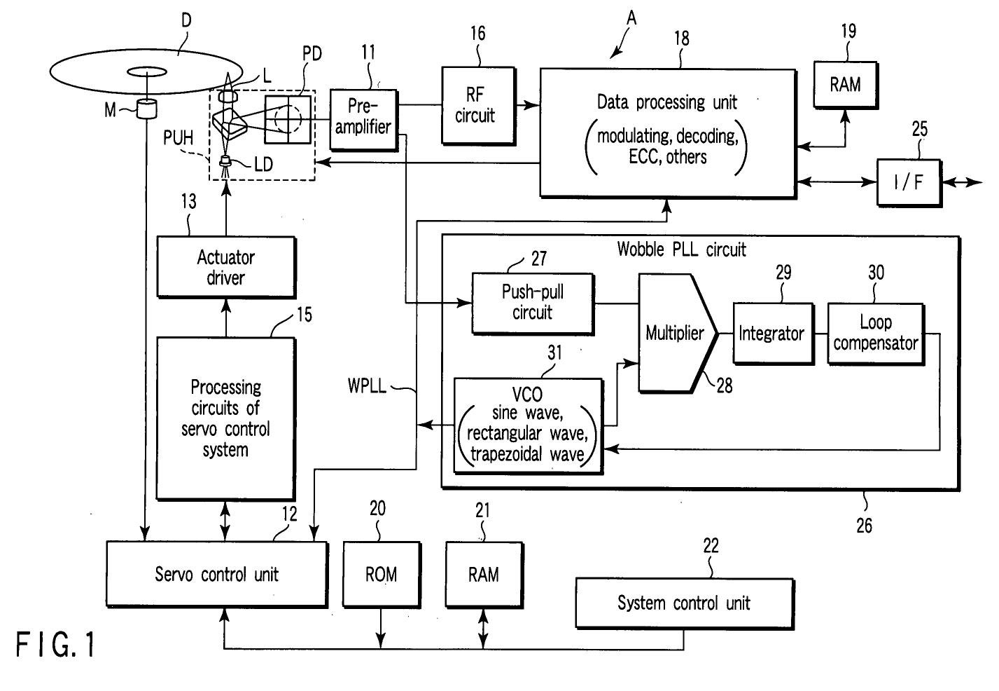

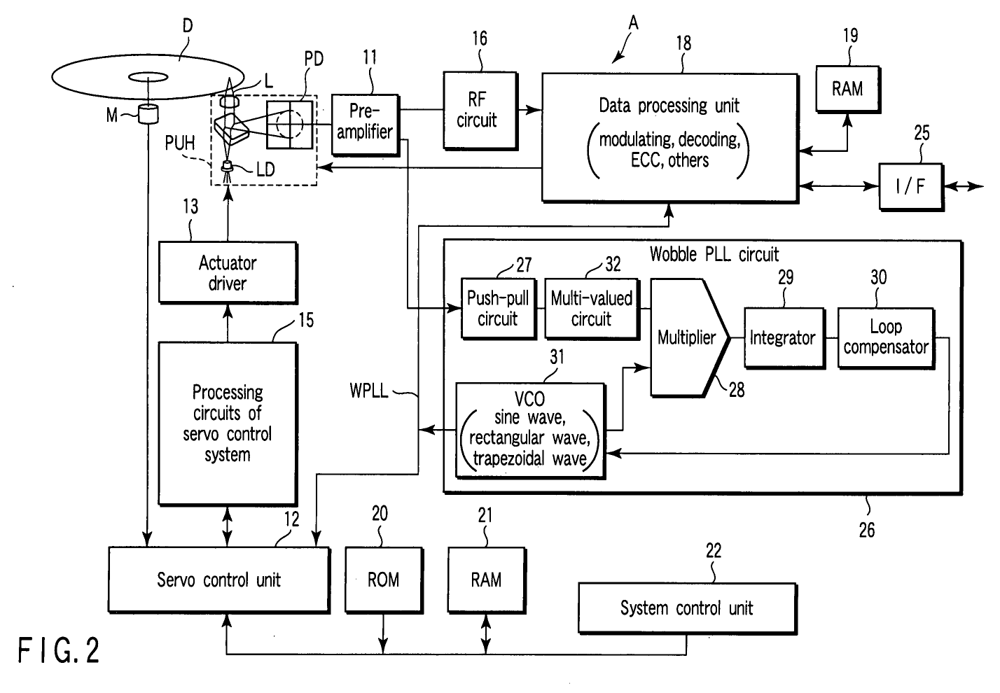

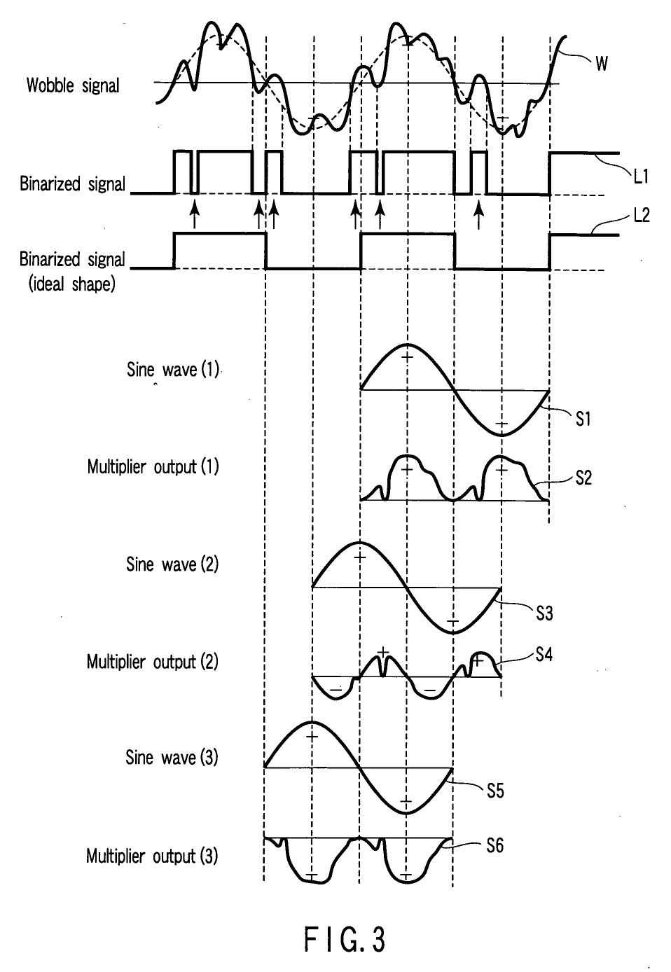

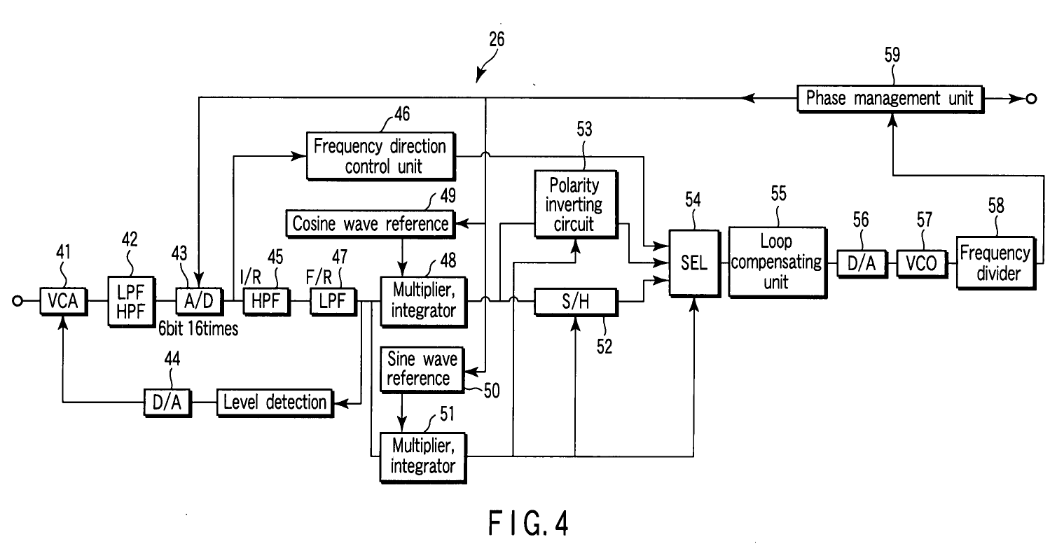

FIGS. 1 and 2 are a block diagram showing the optical disk apparatus according to one embodiment of the invention, FIG. 3 is a timing chart showing a process of generating the wobble PLL signal in the optical disk apparatus according to one embodiment of the invention, and FIG. 4 is the block diagram showing another configuration of a wobble PLL circuit in the optical disk apparatus according to one embodiment of the invention.

### Optical Disk Apparatus according to the Invention

(Basic Configuration and Operation)

In FIG. 1, an optical disk apparatus A according to one embodiment of the invention includes a ROM 20 and a RAM 21 which are of a storage area, a system control unit 22 which controls overall operation, and as driving system, a rotary motor M which rotates an optical disk D at predetermined number of revolutions, and a servo control unit 12. Further, the optical disk apparatus A includes a pickup head PUH which writes information in the optical disk D and reads out the information from the optical disk D. The pickup head PUH includes an objective lens L, a photodetector PD such as a four-channel photodetector, and a laser diode LD which emits a laser beam.

The servo control unit 12 is connected to processing circuits of servo control system 15. The processing circuits of servo control system 15 include an objective lens guiding circuit, a focus control circuit, an objective lens driving signal switch, an objective lens driving circuit, a wobble signal detector and the like, which are not shown. The processing circuits of servo control system 15 perform focus retracting operation and the like.

The optical disk apparatus A also includes a preamplifier 11 to which a detection signal is supplied from the photodetector PD of the pickup head PUH, an RF circuit 16 to which an amplified signal is supplied from the preamplifier 11, and a wobble PLL circuit 26. The RF circuit 16 includes a data processing unit 18 which perform coding/decoding processing or ECC processing to a signal to be recorded which is given from the outside or the detection signal which is detected by the pickup head PUH. The data processing unit 18 is connected to a RAM 19 which provides a working area and an interface (I/F) 25 which exchanges the signal between the optical disk apparatus A and an external device.

A wobble PLL circuit 26 which is a feature of the invention includes a push-pull circuit 27 to which detection signals (A, B, C, and D) are supplied from the preamplifier 11, a multiplier 28 to which output of the push-pull circuit 27 is supplied, an integrator 29 to which multiplication result of the multiplier 28 is supplied, a loop compensator 30 to which integral result of the integrator 29 is supplied, and a voltage control oscillator (VCO) 31. A control signal of the loop compensator 30 is supplied to the VCO 31, and the VCO 31 generates the oscillation wave by controlling a frequency of the oscillation wave according to the control signal. The VCO 31 oscillates at least one of a sine wave, a rectangular wave, and a trapezoidal wave as the oscillation wave which follows the wobble signal. The frequency of the oscillation wave is controlled by the control signal which is supplied from the loop compensator 30.

In the above configuration, the system control unit 22 uses the RAM 21 as the working area and performs the predetermined operation according to a program including the invention which is recorded in the ROM 20. The optical disk D is irradiated with a light beam outputted from the optical pickup PUH. The reflected light beam from the optical disk D is converted into an electric signal by the preamplifier 11. The electric signal is inputted to the data processing unit 18 through the RF circuit 16.

The objective lens guiding circuit, the focus control circuit, the objective lens driving signal switch, the objective lens driving circuit, the wobble signal detector, and the like, which are not shown and are included in the processing circuits of servo control system 15, perform the focus retracting operation and the like.

As described later, a wobble signal W corresponding to a wobbled pre-groove on the optical disk is detected at the same time as the focus retracting operation. A wobble PLL signal WPLL is generated in response to the wobble signal W by the wobble PLL circuit 26 and supplied to the servo control circuit 12 and the data processing unit 18.

In data writing operation, by using a writing clock generated by a write channel circuit (not shown), the data processing unit 18 adds an error detection code (EDC) and ID to the data transmitted through I/F 25, performs data scramble processing to the data in order to stabilize the servo, adds an error correction code (ECC) to the data, and adds a synchronizing signal to the data. Further, the data processing unit 18 modulates the signals except the synchronizing signal and transmits the signals except the synchronizing signal to a write power control signal unit (not shown). The signals except the synchronizing signal are written in a medium through a laser diode driving circuit (not shown) by optimum write strategy for the corresponding medium.

In data readout operation, the detection signal from the optical pickup PUH is amplified by the preamplifier 11, and an RF signal generated by the RF circuit 16 is transmitted to a read buffer (not shown) and a PLL circuit (not shown) through an optimum equalizer. Channel data is read in the read buffer with a readout clock generated by the PLL circuit. In the data which has been read, synchronized symbol data is read out by the data processing unit 18. Then, error correction processing and disk scramble processing are performed, and the data is transferred to the external device or the like through I/F 25.

(Wobble Signal Processing)

The wobble PLL circuit 26 according to the invention, which generates the wobble PLL signal PLL, will be described in detail referring to the timing chart shown in FIG. 3. The wobbling, i.e. the groove which vibrates in a radial direction is formed in the optical disk D so that the wobbling becomes a clue to obtain a time base of read channel signal processing such as making of a write clock corresponding to a change in linear velocity of the disk. The period of the wobbling is detected as the wobble signal W, and the oscillation wave synchronizing with the wobble signal W is generated as the wobble PLL signal PLL in the wobble PLL circuit 26.

The laser beam which is emitted from the laser diode LD is focused onto a face of the disk through the objective lens L, the detection signal according to the reflected light beam is outputted from the photodetector PD. The photodetector PD include, e.g. a four-divided photo acceptance surface, and the photodetector PD discriminates light intensity according to a diffraction direction. Since the output of the photodetector PD is a very small quantity of electric current, the output is amplified to large voltage by the preamplifier 11 so that subsequent processing is easy to perform. As shown in FIG. 3, in the push-pull circuit 27 included in the wobble PLL circuit 26, the wobble signal W which is of a push-pull signal indicating a balance of a radial diffraction light beam from the groove is generated by performing arithmetic processing of the signal from the preamplifier 11 (generation of a difference signal between two radial surfaces).

As shown in FIG. 3, at this point, it should be noted that the optical disk becomes faster and denser. When the optical disk is influenced by the noise, an ideal shape of the wobble signal W (broken line) is not drawn, but the wobble signal is outputted with the noise as can be seen from the wobble signal W (solid line). When the wobble signal W (solid line) is binarized into the binarized signal by a binarizing circuit without adopting the technique of the invention, a binarized signal L1 including error components (arrows) is outputted. As can be seen from comparison to an ideal binarized signal L2, since the binarized signal L1 includes the error components (arrows), phase comparison to the oscillation wave can not be correctly performed. In the case of using the binarized signal, by the remarkable influence of the noise, there is generated the trouble that the capture range of the wobble PLL signal becomes narrower or the trouble that the phase lock is unlocked.

In the invention, the detected wobble signal W is not binarized, but the wobble signal W is multiplied with the oscillation wave from the VCO 31, the multiplication result is integrated, and frequency control of the oscillation wave is performed according to the integral result. This enables the comparison of the detected wobble signal W and the oscillation wave to perform as a signal area of a period unit. Accordingly, since the small noises do not directly influence the comparison result, even in the faster and denser optical disk, the stable wobble PLL signal can be obtained.

The VCO 31 is the oscillator which can vary the frequency according to control input from the outside. In the wobble PLL circuit 26, a control system is configured so that the frequency and the phase of the oscillator synchronize with the wobble signal W.

The wobble PLL signal WPLL which is of the output of the VCO 31 and the wobble signal W which is the push-pull signal including the wobble are multiplied by the multiplier 28. At this point, since the processing is multiplication, a positive value is outputted when the polarities of the wobble PLL signal WPLL and the wobble signal W are matched with each other, and negative value is outputted when the polarities of the wobble PLL signal WPLL and the wobble signal W are different from each other.

Assuming that the frequencies of the wobble PLL signal WPLL and the wobble signal W are almost matched with each other but the frequencies of the wobble PLL signal WPLL and the wobble signal W are not completely matched with each other, when the multiplication result is averaged with a time constant and observed, the multiplication result becomes the positive value in the case where phase polarities of the wobble PLL signal WPLL and the wobble signal W are matched with each other, and the multiplication result becomes the negative value in the case where the phase polarities of the wobble PLL signal WPLL and the wobble signal W become an opposite phase respectively.

As shown in FIG. 3, multiplier outputs S2, S4, and S6 are obtained by the multiplication processing of sine waves S1, S3, and S5 which are of the oscillation wave of the wobble signal W and VCO 31. However, the sine wave is used as the oscillation wave in FIG. 3, the rectangular wave, the trapezoidal wave, or the like can be used as the oscillation wave.

When the phase of the sine wave S1 corresponds to the phase of the wobble signal W, the maximum multiplier output S2 is obtained by the integrator 29. When the phase difference between the sine wave S3 and the wobble signal W is ±90 degrees, the multiplier output S4 having the almost zero value is obtained. When the phase difference between the sine wave S5 and the wobble signal W is ±180 degrees (opposite phase), the multiplier output S6 having the negative maximum value is obtained.

The multiplier outputs S2, S4, and S6 are integrated by the integrator 29, and the frequency control of the oscillation wave such as the sine wave can be performed according to the integral value in the VCO 31 by supplying the signal of the integral result to the loop compensator 30. It is preferable that integral action time of the integrator 29 is an integral multiple of one period of the VCO 31 which is of the oscillator.

A point where the phase of the signal of the VCO 31 is 90 degrees leading from the phase of the wobble signal W is set to a set convergent point, the oscillation frequency is controlled so as to be increased when the phase of the signal of the VCO 31 approaches the phase of the wobble signal W (phase difference is 0 degree), and the oscillation frequency is controlled so as to be decreased when the phases of the signal of the VCO 31 approaches the opposite phase. This enables the phase of the oscillation wave of the VCO 31 to synchronize with the phase of the wobble signal W.

With reference to open-loop transfer characteristics of the control system, since phase information is returned as the change in frequency in the case of simple negative feedback, the control system is stabilized as a first order time-lag system. However, the state in which the phases of the wobble signal W and the signal of the VCO 31 are shifted from 90 degrees is required in order to generate a value for controlling the frequency of the VCO 31, and control ranges from a control set point becomes asymmetry. Accordingly, in the loop compensator 30, it is preferable that steady-state deviation is eliminated by performing integral compensation of the electric current lower than a control band. Further, since sometimes the integral compensation obstructs the convergence during the convergence, it is preferable that the integral compensation is operated after. confirming the convergence, or it is preferable that derivative compensation is introduced only during the convergence.

For example, the wobble PLL signal WPLL obtained from the VCO 31 is supplied to the data processing circuit 18 and used as a reference signal in the reproduction processing of the detection signal or recording processing of the given signal. Further, the wobble PLL signal WPLL is supplied to the servo control unit 12 and used as the reference signal in controlling rotational speed of the rotary motor M in order to make linear velocity of the optical disk D constant.

As shown in FIG. 2, it is preferable that the wobble signal W is converted into not an analog signal but a multi-valued signal such as 8 bits, 16 bits, and 64 bits to perform the same processing by inserting a multi-valued circuit 32 into a subsequent stage of the push-pull circuit 27 in the wobble PLL circuit 26. It is also preferable to provide the multi-valued circuit 32 between the multiplier 28 and the integrator 29 or to provide the multi-valued circuit 32 in other places. In recent years, because an integrated circuit for digital processing can be obtained at low cost, the multi-valued signal often obtains high-speed processing at lower cost, compared with the analog signal. In this case, the wobble signal W is not binarized by setting a slice level, so that the stable and noise-resistant wobble PLL signal WPLL which is of the advantage of the invention can be obtained.

According to the wobble PLL circuit 26 of the optical disk apparatus of the invention, the phase comparison of the detected wobble signal W and the oscillation wave such as the sine wave is performed in the signal area by performing the multiplication processing of the wobble signal W and the oscillation wave and by performing the integral processing of the multiplication processing, so that even if the noise smaller than the wobble is mixed, the wobble PLL circuit 26 is hardly affected by the noise and noise-resistant characteristics can be dramatically improved, compared with the case of the use of the conventional binarizing processing.

### Another Embodiment

The configuration shown in FIG. 4 is preferable to the wobble PLL circuit 26 of the optical disk apparatus according to the invention. The wobble PLL circuit 26 shown in FIG. 4 includes a voltage control amplifier (VCA) 41 to which the wobble signal W is supplied from the push-pull circuit 27, a low-pass filter (LPF)/high-pass filter (HPF) 42 which are connected to the VCA 41, an A/D converter 43 which is connected to the LPF/HPF 42, an HPF 45 which is connected to the A/D converter 43, an LPF 47 which is connected to the HPF 45, a level detector 40 which obtains the output from the LPF 47, and a D/A converter 44 which is connected to the level detector 40. The wobble PLL circuit 26 also includes multiplier/integrator 48 which receive the output of the LPF 47, a cosine wave reference 49 which supplies a cosine wave and receives the control signal from a phase management unit 59, a threshold circuit 52 which receives the output of the multiplier/integrator 48, multiplier/integrator 51 which receive the output of the LPF 47, a sine wave reference 50 which supplies the sine wave and receives the control signal from the phase management unit 59, a polarity inverting unit 53 which receives the outputs of the multiplier/integrator 48 and 51 to invert the polarity, and a frequency direction control unit 46 which receives the output of the A/D converter 43 to control the frequency direction. Further, the wobble PLL circuit 26 includes a selector unit 54 which receives the outputs of the frequency direction control unit 46, the polarity inverting unit 53, and the threshold circuit 52 and outputs one of these outputs according to the output of the multiplier/integrator 51, a loop compensating unit 55 which receives the output of the selector unit 54, a D/A converter 56 which receives the output of the loop compensating unit 55, a VCO 57 which receives the output of the D/A converter 56, a frequency divider 58 which receives the output of the VCO 57, and the phase management unit 59 which receives the output of the frequency divider 58 to perform phase management.

According to the configuration shown in FIG. 4, the frequency of the wobble signal W and the frequency of the oscillation wave of the VCO 31 are compared by providing the frequency direction control unit 46. For example, in the case where the frequency difference is not lower than 10%, the output of the frequency direction control unit 46 is supplied to the loop compensating unit 55 by action of the selector unit 54. Accordingly, the frequency of the cosine wave which becomes the wobble PLL signal WPLL can be correctly and efficiently controlled in the cosine wave reference 49. When the polarity inversion of the wobble signal is detected, the signal is inversed and outputted by the action of the polarity inverting unit 53. Further, by providing the sine wave reference 50 which outputs a second oscillation wave and the multiplier/integrator 51 of the sine wave reference 50, a polarity inversion point of the wobble signal is detected, a sink point of the wobble is detected, and the code is detected. The further stable wobble PLL signal WPLL can be obtained by utilizing these detection results.

Although those skilled in the art can realize the invention by the various embodiments described above, various modifications of these embodiments could be easily made by those skilled in the art, and the invention can be applied to various modes without any inventive ability. Therefore, the invention is not limited to the above embodiments, but the invention covers broad scope which is consistent with the disclosed principles and novel features.

As described above, according to the invention, the phase comparison can be performed in the signal area in such a manner that the wobble signal detected on the basis of the wobble of the pre-groove in the optical disk and the sine wave or the like of the oscillator are multiplied and integrated for a certain period. Therefore, the optical disk apparatus and optical disk processing method which can obtain the stable wobble PLL signal without substantially affecting the small noise.

What is claimed is:

1. An optical disk apparatus comprising:
a generating unit which generates a wobble signal in response to a wobbled groove on an optical disk on the basis of a reflected light beam detected from the optical disk;
a multiplying unit which receives the wobble signal from the generating unit and a given oscillation wave and multiplies the wobble signal and the oscillation wave;
an integral processing unit which receives a multiplication result of the multiplying unit and integrates the multiplication result;
an oscillating unit which generates the oscillation wave and supplies the oscillation wave to the multiplying unit, an oscillation frequency of the oscillation wave being controlled on the basis of integral result of the integral processing unit; and
a processing unit which processes information on the optical disk on the basis of the oscillation wave from the oscillating unit.

2. An optical disk apparatus according to claim 1, wherein the multiplying unit multiplies the wobble signal and the oscillation wave without binarizing the wobble signal from the generating unit.

3. An optical disk apparatus according to claim 1, wherein integral action time of the integral processing unit is an integral multiple of one period of the oscillating unit.

4. An optical disk apparatus according to claim 1, wherein the oscillating unit generates the oscillation wave which is of a sine wave.

5. An optical disk apparatus according to claim 1, wherein the oscillating unit generates the oscillation wave which is of a rectangular wave.

6. An optical disk apparatus according to claim 1, wherein the oscillating unit generates the oscillation wave which is of a trapezoidal wave.

7. An optical disk apparatus according to claim 1, further comprising:
a servo control unit which controls a number of revolutions on the basis of the oscillation wave from the oscillating unit in order to make linear velocity of the optical disk constant.

8. An optical disk apparatus according to claim 1, further comprising:
a multi-valued circuit which converts the wobble signal outputted from the generating unit into a multi-valued signal except a binary signal.

9. An optical disk apparatus according to claim 1, further comprising:
a second oscillating unit which outputs a second oscillation wave; and
a sample holding unit which performs sample hold of the integral result of the integral processing unit on the basis of the second oscillation wave.

10. An optical disk apparatus according to claim 1, further comprising:
a frequency direction control unit which controls the oscillation frequency of the oscillating unit on the basis of frequency difference between the wobble signal and the oscillation wave.

11. An optical disk processing method comprising:
generating a wobble signal in response to a wobbled groove on an optical disk on the basis of a reflected light beam detected from the optical disk;
receiving the wobble signal and a given oscillation wave to multiply the wobble signal and the oscillation wave;
receiving the multiplication result to integrate the multiplication result;
generating the oscillation wave whose oscillation frequency is controlled on the basis of the integral result; and
processing information on the optical disk on the basis of the oscillation wave.

12. An optical disk processing method according to claim 11, wherein multiplication processing of the wobble signal and the oscillation wave without binarizing the wobble signal in the multiplication.

13. An optical disk processing method according to claim 11, wherein integral action time of the integration is an integral multiple of one period of the oscillation.

14. An optical disk processing method according to claim 11, wherein the oscillating wave which is of a sine wave is generated in the oscillation.

15. An optical disk processing method according to claim 11, wherein the oscillating wave which is of a rectangular wave is generated in the oscillation.

16. An optical disk processing method according to claim 11, wherein the oscillating wave which is of a trapezoidal wave is generated in the oscillation.

17. An optical disk processing method according to claim 11, wherein a number of revolutions is controlled on the basis of the oscillation wave in order to make linear velocity of the optical disk constant.

18. An optical disk processing method according to claim 11, wherein the generated wobble signal is converted into a multi-valued signal except a binary signal.

19. An optical disk processing method according to claim 11, wherein a second oscillation wave is oscillated, and sample hold of the integral result is performed on the basis of the second oscillation wave.

20. An optical disk processing method according to claim 11, wherein the oscillation frequency of the oscillating wave is controlled on the basis of frequency difference between the wobble signal and the oscillation wave.
